(19) United States
(12) Patent Application Publication
(10) Pub. No.: US 2009/0085961 A1
(43) Pub. Date: Apr. 2, 2009

(54) FLUID EJECTING APPARATUS

(75) Inventor: Jun SHIMAZAKI, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/243,011

(22) Filed: Oct. 1, 2008

(30) Foreign Application Priority Data
Oct. 2, 2007 (JP) 2007-259047

(51) Int. Cl. B41J 2/165

(52) U.S. Cl. 347/29

(57) ABSTRACT

A fluid ejecting apparatus that ejects fluid includes: a head capable of performing effective discharge processing, in which the head discharges the fluid toward a processing object arranged at a predetermined position, and pre-discharge processing, in which the head discharges the fluid independently of the effective discharge processing; a carriage that carries the head and adjusts a position where the head discharges the fluid; a moisture retention head cap unit that covers a discharging surface of the head; a pre-discharge reservoir that receives the fluid discharged from the head when the head performs the pre-discharge processing; and an opening cap portion configured to cover an opening formed in the pre-discharge reservoir for receiving the fluid, when the moisture retention head cap unit covers the discharging surface.

### CROSS-REFERENCE TO RELATED APPLICATIONS

This application is based upon and claims the benefit of priority from prior Japanese Patent Applications No. 2007-259047, filed on Oct. 2, 2007, the entire contents of which are incorporated herein by reference.

### BACKGROUND

1. Technical Field

The present invention relates to a technique for solving clogging of nozzles of a fluid ejecting apparatus that ejects fluid.

2. Related Art

Ink jet recoding apparatuses discharge ink onto recording paper or the like through nozzles. Thickened ink near the nozzles or bubbles in the nozzles sometimes clog the nozzles and prevent ink from being properly discharged. To counter this situation, JP-A-2003-334962 discloses an ink jet recoding apparatus having a cap dedicated to covering a discharging surface of a head. A negative pressure is created in the cap so that bubbles or thickened ink remaining in the nozzles can be vacuumed (hereinafter, “vacuum recovery processing”).

The dedicated cap has an absorbing member for absorbing ink. Thickened ink vacuumed from the nozzles is discharged in the dedicated cap, and the absorbing member absorbs the ink. In an ink jet recoding apparatus that performs the vacuum recovery processing, while it does not perform the vacuum recovery processing (i.e., during print processing), the dedicated cap is opened. Therefore, thickened ink absorbed by the absorbing member in the dedicated cap dries, causing clogging of the absorbing member. This degrades the ink-absorbing performance of the dedicated cap and the power of vacuuming the nozzles.

This problem can occur not only with the cap dedicated to the vacuum recovery processing, but also with a cap used in a so-called flushing operation, in which, for example, a predetermined amount of ink is discharged from all the nozzles to remove thickened ink. That is, this problem can occur with a cap used in processing for discharging ink from the nozzles (hereinafter, “pre-discharge processing”), which is performed independently of the print processing. This problem can occur not only with an ink jet recoding apparatus, but also with a fluid ejecting apparatus that ejects fluid other than ink (examples of such fluid include liquid, liquid-state body in which particles of a functional material are dispersed, and solid body including powder that can be ejected as fluid).

### SUMMARY

An advantage of some aspects of the invention is that it provides a technique for preventing fluid discharged in a pre-discharging head cap of a fluid ejecting apparatus from drying.

The invention can be embodied in the following embodiments and application examples.

### APPLICATION EXAMPLE 1

A fluid ejecting apparatus that ejects fluid includes: a head capable of performing effective discharge processing, in which the head discharges the fluid toward a processing object arranged at a predetermined position, and pre-discharge processing, in which the head discharges the fluid independently of the effective discharge processing; a carriage that carries the head and adjusts a position where the head discharges the fluid; a moisture retention head cap unit that covers a discharging surface of the head; a pre-discharge reservoir that receives the fluid discharged from the head when the head performs the pre-discharge processing; and an opening cap portion configured to cover an opening formed in the pre-discharge reservoir for receiving the fluid, when the moisture retention head cap unit covers the discharging surface.

In the fluid ejecting apparatus according to the application example 1, when the moisture retention head cap unit covers the discharging surface of the head, the opening of the pre-discharge reservoir is covered by the opening cap portion. Accordingly, it is possible to suppress drying of fluid discharged in the pre-discharge reservoir.

### APPLICATION EXAMPLE 2

The fluid ejecting apparatus according to Application Example 1 may further include a moisturizing tank that is connected to the pre-discharge reservoir and moisturizes an inside of the pre-discharge reservoir.

This configuration makes it possible to moisturize the inside of the pre-discharge reservoir using the moisturizing tank. Accordingly, drying of the inside of the pre-discharge reservoir can be further suppressed compared to a configuration that does not use the moisturizing tank.

### APPLICATION EXAMPLE 3

The fluid ejecting apparatus according to Application Example 1 may further include a cap-surface cap unit configured to cover a cap surface of the moisture retention head cap unit when the pre-discharge reservoir covers the discharging surface.

This configuration makes it possible to cover the cap surface of the moisture retention cap unit by the cap-surface cap unit while the head performs the pre-discharge processing. Accordingly, drying of the inside of the moisture retention cap unit can be suppressed.

### APPLICATION EXAMPLE 4

In the fluid ejecting apparatus according to Application Example 1, the opening cap portion may (i) constitute a part of the discharging surface, and (ii) be configured to contact the pre-discharge reservoir and cover the opening.

This configuration makes it possible to cover the opening of the pre-discharge reservoir using a part of the discharging surface. In addition, because there is no need to prepare a member serving as the opening cap portion separately from the head, an increase in the manufacturing cost of the fluid ejecting apparatus can be suppressed.

### APPLICATION EXAMPLE 5

In the fluid ejecting apparatus according to Application Example 1, the opening cap portion may (i) constitute a part of a bottom surface of the carriage, and (ii) be configured to contact the pre-discharge reservoir and cover the opening.

This configuration makes it possible to cover the opening of the pre-discharge reservoir using a part of the bottom surface of the carriage. In addition, because there is no need to prepare a member serving as the opening cap portion separately from the head, an increase in the manufacturing cost of the fluid ejecting apparatus can be suppressed.

### BRIEF DESCRIPTION OF THE DRAWINGS

The invention will be described with reference to the accompanying drawings, wherein like numbers reference like elements.

FIG. 1 shows a schematic structure of an ink jet printer as an exemplary fluid ejecting apparatus of the invention.

FIG. 2A is a schematic sectional view of a carriage 10 shown in FIG. 1, and FIG. 2B is a bottom view of the carriage 10.

FIG. 3 shows a detailed structure around a home position H1 just after the arrival of the carriage 10 at the home position H1.

FIG. 4 shows a detailed structure around the home position H1 in a power-off state.

FIG. 5 shows a detailed structure around the home position H1 according to a second example.

FIG. 6 shows a detailed structure around the home position H1 according to a third example.

FIG. 7 shows a detailed structure around the home position H1 according to the third example, in a power-off state.

FIG. 8 shows a detailed structure around the home position H1 according to a fourth example.

FIG. 9 shows a detailed structure around the home position H1 according to the fourth example, in a power-off state.

### DESCRIPTION OF EXEMPLARY EMBODIMENTS

Most preferable embodiments of the invention will be described below on the basis of the examples in the following order:
A. First Example;
B. Second Example;
C. Third Example;
D. Fourth Example; and
E. Modification Examples.

### A. FIRST EXAMPLE

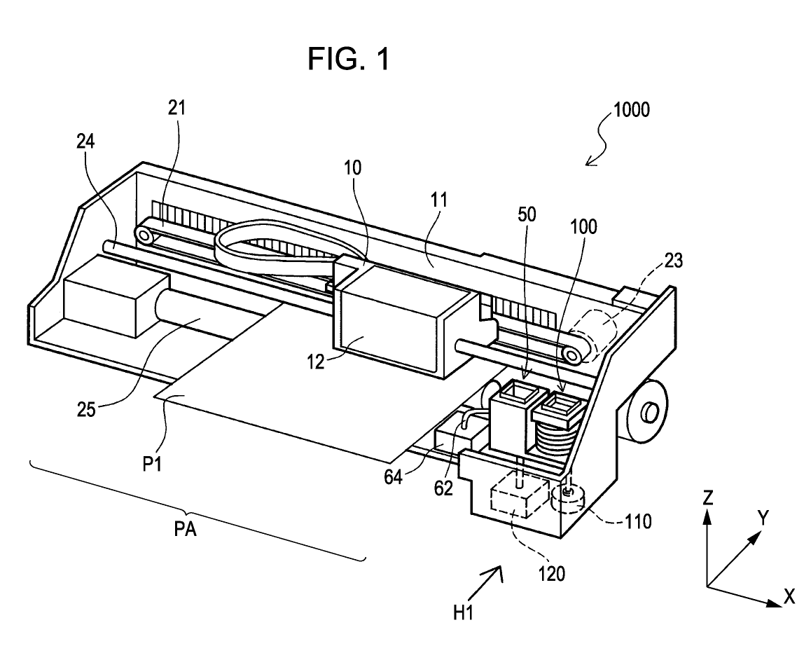

FIG. 1 shows a schematic structure of an ink jet printer as an exemplary fluid ejecting apparatus of the invention. A printer 1000 has a frame 11, in which a platen 25 is disposed. A paper feeding mechanism (not shown) transports printing paper P1 on the platen 25. The printer 1000 also has a carriage 10, which is supported by a guide member 24 in a movable manner in a longitudinal direction (X-axis direction) of the platen 25 and is reciprocated by a carriage motor 23 through a timing belt 21.

An ink cartridge 12 is mounted in the carriage 10. An ink jet recording head (not shown, and hereinafter, “head”) is mounted to the bottom surface of the carriage 10. The carriage 10 moves along the platen 25 to reciprocate the head above the printing paper P1. At this time, ink is discharged from the head, whereby the print processing is performed. The print processing corresponds to effective discharge processing as set forth in the claims. The printer 1000 performs processing for discharging a predetermined amount of ink from all the nozzles (flushing) independently of the print processing, to remove bubbles or thickened ink remaining in the nozzles (not shown). The flushing corresponds to pre-discharge processing as set forth in claims.

An area in which the head can discharge ink (hereinafter, “print area”) PA is provided in the frame 11, and a non-print area in which the head does not discharge ink is provided next to the print area PA. A home position H1 is provided in the non-print area. The carriage 10 is movable between the print area PA and the home position H1.

A flushing cap unit 50, a moisture retention cap unit 100, a moisturizing tank 64, a tube 62, a vacuum pump 110, and a lifting unit 120 are disposed at the home position H1. The flushing cap unit 50 receives ink discharged from the head at the time of flushing. In a power-off state, the moisture retention cap unit 100 is positioned to cover the discharging surface of the head, for the following reason. After the print processing, ink droplets sometimes remain on the discharging surface of the head. When ink deposited on the discharging surface dries, the ink clogs the nozzle holes, resulting in possible discharge failure. To prevent ink deposited on the discharging surface from drying, the discharging surface of the head is covered by the moisture retention cap unit 100, when the power is off. The vacuum pump 110 creates negative pressure in the moisture retention cap unit 100. By creating negative pressure in the moisture retention cap unit 100 when it covers the head, ink and bubbles remaining in the nozzles are forcibly discharged (vacuum recovery processing is performed).

The moisturizing tank 64 is connected to the flushing cap unit 50 through the tube 62 to moisturize the inside of the flushing cap unit 50. This prevents ink remaining in the flushing cap unit 50 (ink discharged at the time of flushing) from drying and enables the ink to be easily discharged. The lifting unit 120 can raise and lower the flushing cap unit 50 and the moisture retention cap unit 100. A known lifting mechanism, for example, a combination of a motor and a screw, may be used as the lifting unit 120. The moisturizing tank 64 and the tube 62 may be omitted.

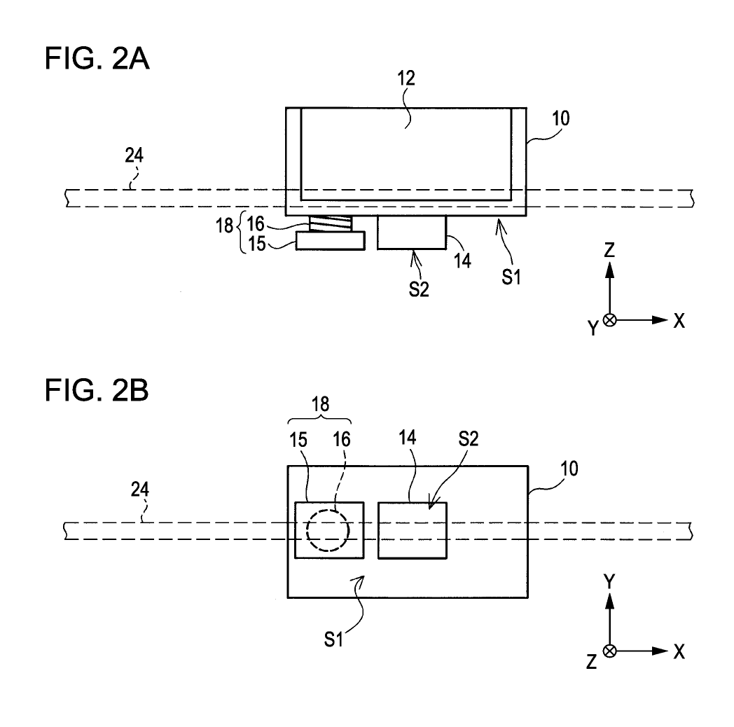

FIG. 2A is a schematic sectional view of the carriage 10 shown in FIG. 1, and FIG. 2B is a bottom view of the carriage 10. The head 14 and a cap portion 18 for covering an opening (hereinafter, an “opening cap portion”) are provided on a bottom surface S1 of the carriage 10. The opening cap portion 18 includes a cap member 15 and a supporting member 16. The supporting member 16 is connected to the bottom surface S1 at one end and to the cap member 15 at the other end to support the cap member 15. The supporting member 16 is made of an elastic body. Vertical expansion and contraction of the supporting member 16 allows the cap member 15 to move vertically. In the example shown in FIGS. 2A and 2B, neither the opening cap portion 18 nor the head 14 is in contact with something. In this state, the bottom surface of the cap member 15 and a bottom surface (discharging surface) S2 of the head 14 are on the same level. The supporting member 16 may be made of, for example, a spring or synthetic rubber.

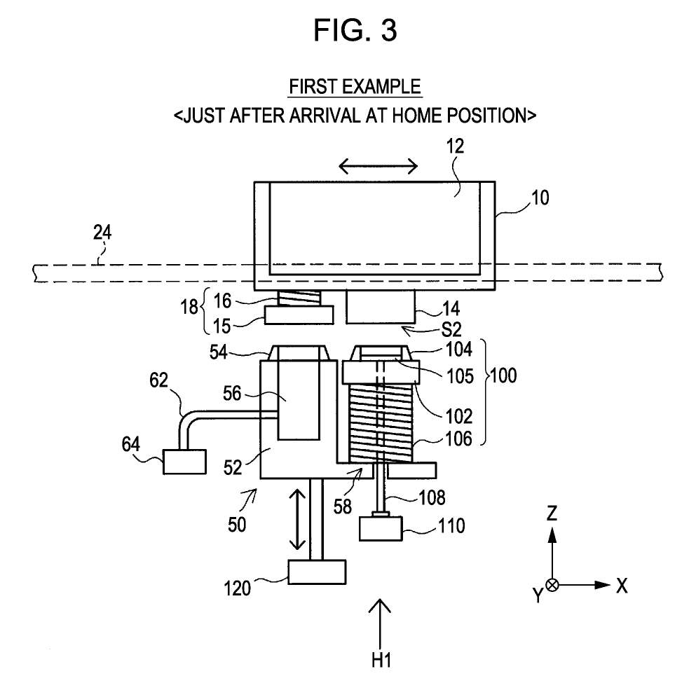

FIG. 3 shows a detailed structure around the home position H1 just after the arrival of the carriage 10 at the home position H1. The moisture retention cap unit 100 includes a cap holder 102, a cap portion 104 arranged on the cap holder 102 such that it projects in the Z-axis direction, a sheet sponge 105 disposed at the bottom of the space surrounded by the cap portion 104, and a supporting member 106 that supports the cap holder 102 from below. Like the supporting member 16 (FIG. 2A), the supporting member 106 may be made of, for example, a spring or synthetic rubber. The sponge 105 is connected to the vacuum pump 110 through the tube 108 penetrating the cap holder 102 and the supporting member 106. The sponge 105 receives and absorbs residual ink forcibly discharged from the nozzles in the vacuum recovery processing.

The flushing cap unit 50 includes a frame member 52, a cap portion 54 arranged on the frame member 52 such that it projects in the Z-axis direction, and a hollow ink reservoir 56 formed in the frame member 52. The ink reservoir 56 is connected to the moisturizing tank 64 through the tube 62. The ink reservoir 56 receives and stores ink discharged from the head 14 in the flushing processing. A part of the bottom surface of the frame member 52 projects in the X-axis direction and constitutes a plate-like portion 58. The moisture retention cap unit 100 is placed on the plate-like portion 58, with the supporting member 106 of the moisture retention cap unit 100 being fixed to the plate-like portion 58. In the example shown in FIG. 3, the top surface of the cap portion 54 and the top surface of the cap portion 104 are on the same level. The lifting unit 120 is provided below the flushing cap unit 50. The lifting unit 120 can raise and lower the flushing cap unit 50. At this time, the moisture retention cap unit 100 arranged on the plate-like portion 58 is also moved vertically.

When the printer 1000 (FIG. 1) performs the print processing and printing is completed, the carriage 10 (FIG. 3) returns to the home position H1. Then, the carriage 10 is positioned such that the head 14 is positioned just above the moisture retention cap unit 100. The opening cap portion 18 is arranged on the bottom surface of the carriage 10 such that the opening cap portion 18 is positioned just above the cap portion 54 of the flushing cap unit 50 at this time. When the printer 1000 is in a power-on state and is ready to perform the print processing, the carriage 10, the flushing cap unit 50, and the moisture retention cap unit 100 are also positioned as shown in FIG. 3.

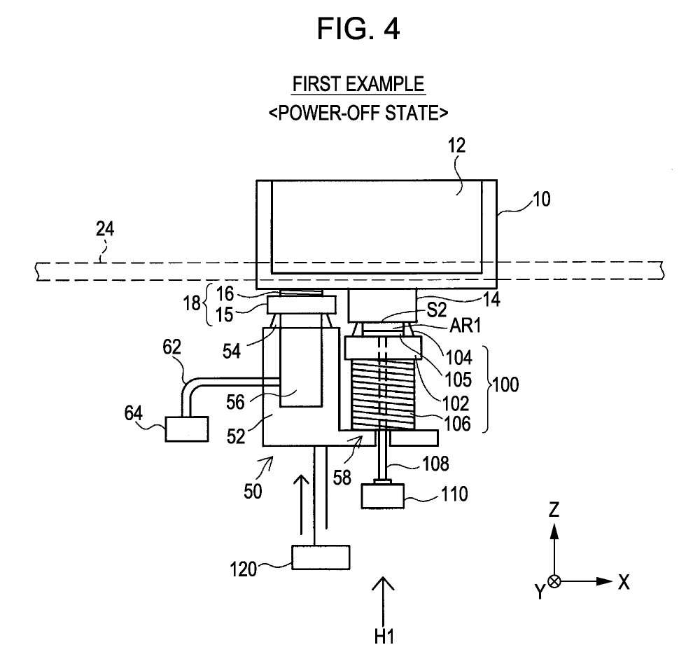

FIG. 4 shows a detailed structure around the home position H1 in a power-off state. When the printer 1000 is in a power-off state, the carriage 10 is positioned at the home position H1. When the printer 1000 is in a power-on state and while it does not perform the print processing or flushing processing (i.e., in a standby state), the carriage 10, the flushing cap unit 50, and the moisture retention cap unit 100 are also positioned as shown in FIG. 4.

For example, when the carriage 10 returns to the home position H1 (refer to FIG. 3) after finishing printing and transits to a standby state, the lifting unit 120 raises the flushing cap unit 50 and the moisture retention cap unit 100. As a result, the cap portion 104 contacts the discharging surface S2, and the cap portion 54 contacts the cap member 15. The lifting unit 120 further raises the flushing cap unit 50 and the moisture retention cap unit 100 by a predetermined amount. As a result, the cap portion 54 pushes up the cap member 15 and the ink reservoir 56 is sealed with the cap member 15. Thus, drying of ink in the ink reservoir 56 is suppressed. The supporting member 16 pushed up by the cap member 15 contracts upward and then tries to expand downward. Thus, the cap member 15 exerts a downward force on the cap portion 54. Accordingly, the airtightness of the ink reservoir 56 is maintained at a high level.

In the moisture retention cap unit 100, the discharging surface S2 of the head 14 pushes down the cap portion 104 to form a substantially air-tightly sealed space AR1 between the sponge 105 and the head 14 (discharging surface S2). Thus, drying of ink absorbed by the sponge 105 is suppressed. The supporting member 106 pushed down by the head 14 contracts downward and then tries to expand upward. Thus, the cap portion 104 exerts an upward force on the head 14 (discharging surface S2). Accordingly, the airtightness of the space AR1 is maintained at a high level.

As has been described, when the printer 1000 is in a power-off state or in a standby state, the discharging surface S2 of the head 14 is covered by the moisture retention cap unit 100, and the flushing cap unit 50 is covered by the opening cap portion 18. Therefore, it is possible to suppress drying of the head 14 (discharging surface S2) and the ink reservoir 56. The supporting member 106 of the moisture retention cap unit 100 and the supporting member 16 of the opening cap portion 18 are made of an elastic body. The lifting unit 120 raises the flushing cap unit 50 and the moisture retention cap unit 100 to the height where the supporting member 106 and the supporting member 16 contract. As a result, the cap member 15 is pressed against the cap portion 54 by the resilience of the supporting member 16, and the cap portion 104 is pressed against the discharging surface S2 because of the resilience of the supporting member 106. Accordingly, the airtightness of the ink reservoir 56 and the space AR1 is maintained at a high level.

### B. SECOND EXAMPLE

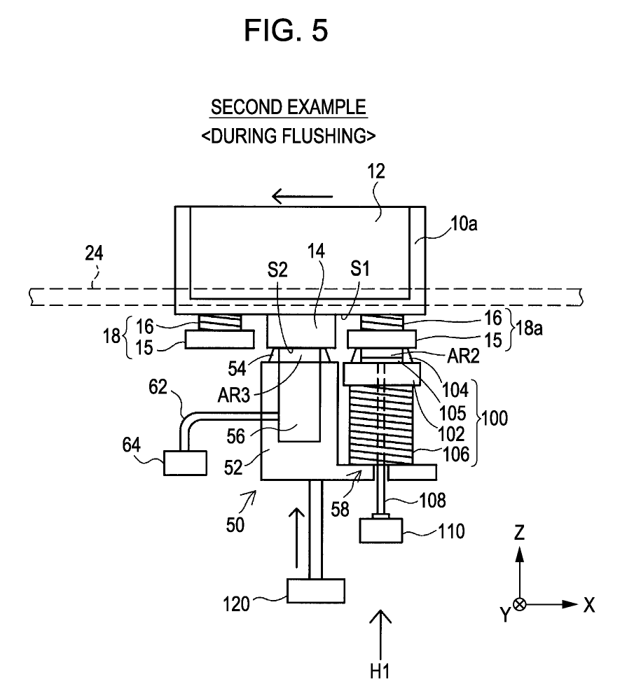

FIG. 5 shows a detailed structure around the home position H1 according to a second example. In the example shown in FIG. 5, the structure around the home position H1 during flushing processing is shown. A printer 1000 according to the second example is different from the printer 1000 (FIGS. 1 to 3) in that it has a moisture-retention-cap-unit cap portion 18a. The other structures are the same as those according to the first example.

More specifically, in the printer 1000 according to the second example, the moisture-retention-cap-unit cap portion 18a for covering the moisture retention cap unit 100 is provided on a bottom surface S1 of a carriage 10a, at a position opposite the opening cap portion 18 with the head 14 therebetween. Because the structure of the moisture-retention-cap-unit cap portion 18a is the same as that of the opening cap portion 18, an explanation thereof is omitted. The supporting member 16 of the moisture-retention-cap-unit cap portion 18a does not have to be made of an elastic body, but may be made of a low-elasticity material such as metal or synthetic resin. The moisture-retention-cap-unit cap portion 18a corresponds to a cap-surface cap unit as set forth in the claims.

When the printer 1000 starts the flushing processing, the carriage 10a is positioned such that the head 14 is positioned just above the flushing cap unit 50 (cap portion 54). The lifting unit 120 raises the flushing cap unit 50, and the cap portion 54 covers the head 14 (discharging surface S2). When the head 14 discharges ink, the ink reservoir 56 receives and stores the discharged ink. At this time, the cap portion 104 of the moisture retention cap unit 100 is covered by the moisture-retention-cap-unit cap portion 18a. Thus, a substantially air-tightly sealed space AR2 enclosed by the cap portion 104 and the moisture-retention-cap-unit cap portion 18a is formed. Accordingly, it is possible to suppress drying of ink absorbed by the sponge 105 during the flushing processing. The printer 1000 according to the second example has the same advantage as that according to the first example.

### C. THIRD EXAMPLE

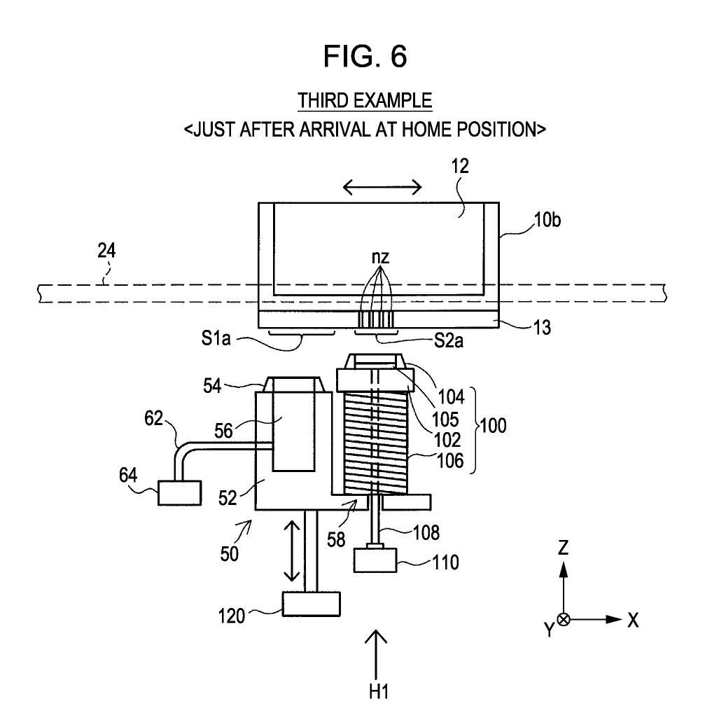

FIG. 6 shows a detailed structure around the home position H1 according to a third example. Similarly to the example shown in FIG. 3, the example of FIG. 6 shows the structure around the home position H1 just after the arrival of a carriage 10b at the home position H1. A printer 1000 according to the third example is different from the printer 1000 (FIGS. 1 to 3) according to the first example in the structure of the head and the height of the moisture retention cap unit 100 in a normal state. The other structures are the same as those according to the first example.

More specifically, the printer 1000 according to the third example has a nozzle plate 13 at the bottom surface of the carriage 10b, which has the same size as the bottom surface of the carriage 10b. The nozzle plate 13 has a plurality of nozzles nz in the center thereof. In the nozzle plate 13, an area S2a where the plurality of nozzles nz are provided is surrounded by an area S1a where the nozzles nz are not provided.

Unlike the first example, in a state where the cap portion 104 is not in contact with the nozzle plate 13, the top surface of the cap portion 104 of the moisture retention cap unit 100 is positioned higher than the top surface of the cap portion 54 of the flushing cap unit 50. This can be achieved by, for example, increasing the height of the supporting member 106 compared to that according to the first example. The area S1a in the third example corresponds to an opening cap portion as set forth in the claims.

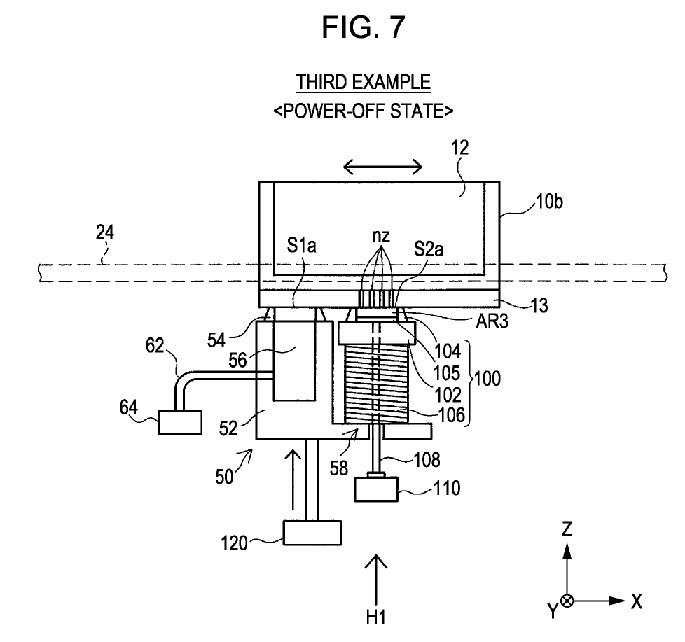

FIG. 7 shows a detailed structure around the home position H1 according to the third example, in a power-off state. When the printer 1000 is in a power-off state or transits to a standby state, the lifting unit 120 raises the flushing cap unit 50 and the moisture retention cap unit 100, similarly to the first example. As a result, the cap portion 104 first comes into contact with the area S2a. At this time, the cap portion 54 of the flushing cap unit 50 is not yet in contact with the nozzle plate 13 (this state is not shown in FIG. 7). When the flushing cap unit 50 and the moisture retention cap unit 100 are further raised, the cap portion 54 comes into contact with the nozzle plate 13 (area S1a), as shown in FIG. 7.

At this time, the cap portion 104 of the moisture retention cap unit 100 is covered by the area S2a, whereby a substantially air-tightly sealed space AR3 is formed. The ink reservoir 56 of the flushing cap unit 50 is covered by the nozzle plate 13 (area S1a). Accordingly, the printer 1000 according to the third example has the same advantage as that according to the first example.

### D. FOURTH EXAMPLE

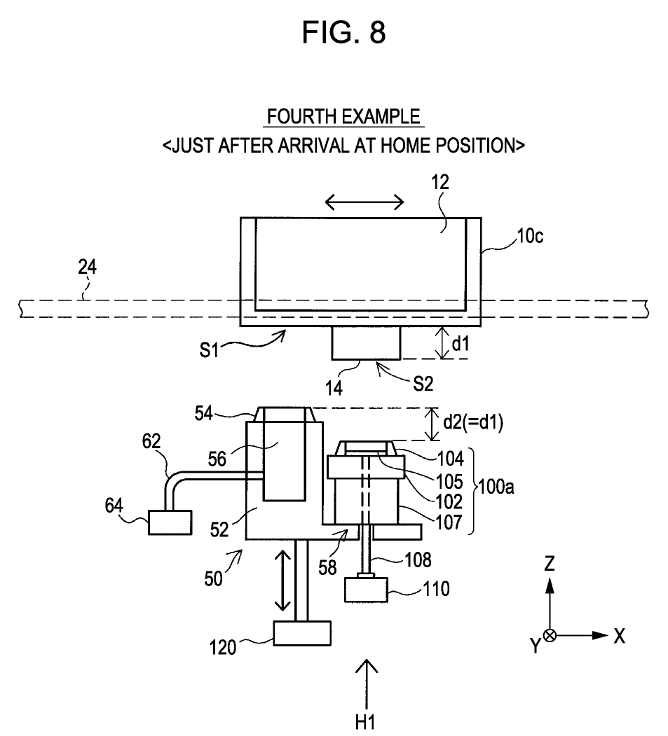

FIG. 8 shows a detailed structure around the home position H1 according to a fourth example. Similarly to the example shown in FIG. 3, the example of FIG. 8 shows the structure around the home position H1 just after the arrival of a carriage 10c at the home position H1. A printer 1000 according to the fourth example is different from the printer 1000 (FIGS. 1 to 3) according to the first example in the structures of the carriage 10c and a moisture retention cap unit 100a. The other structures are the same as those according to the first example.

More specifically, unlike the first example, the carriage 10c does not have the opening cap portion 18 on the bottom surface S1. In addition, unlike a supporting member 106 according to the first example, the supporting member 107 of the moisture retention cap unit 100a is made of a low-elasticity material such as metal or synthetic resin.

Unlike the first example, the top surface of the cap portion 104 of the moisture retention cap unit 100a is positioned lower than the top surface of the cap portion 54 of the flushing cap unit 50. The difference, d2, between the levels of the top surfaces of the cap portion 54 and the cap portion 104 is equal to the height of the head 14, d1 (the difference between the levels of the bottom surface S1 of the carriage 10c and the discharging surface S2 of the head 14). In the third example, the area S1a corresponds to the opening cap portion as set forth in the claims.

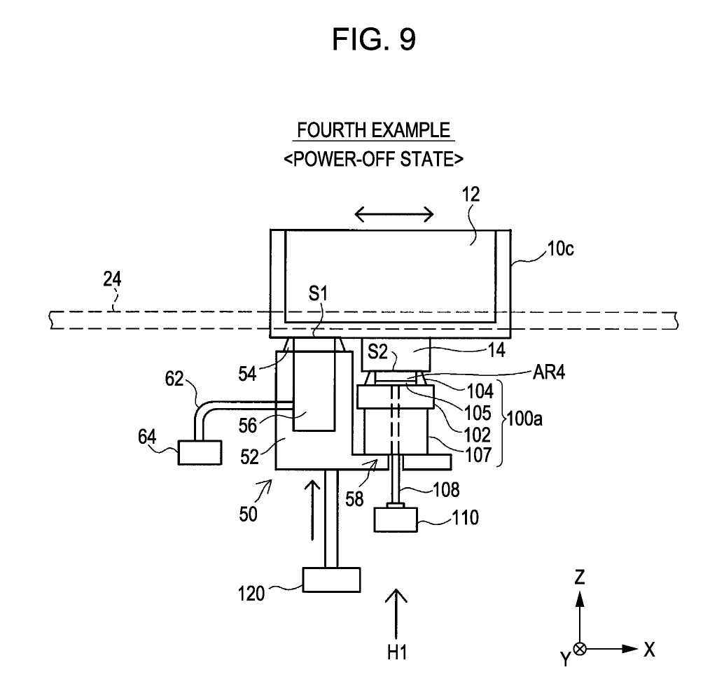

FIG. 9 shows a detailed structure around the home position H1 according to the fourth example, in a power-off state. When the printer 1000 is in a power-off state or transits to a standby state, the lifting unit 120 raises the flushing cap unit 50 and the moisture retention cap unit 100, similarly to the first example. As a result, the cap portion 104 of the moisture retention cap unit 100a comes into contact with the discharging surface S2. At this time, in the moisture retention cap unit 100a, a substantially air-tightly sealed space AR4 enclosed by the cap portion 104 and the discharging surface S2 is formed.

As mentioned above, the difference, d2, between the levels of the top surfaces of the cap portion 54 and the cap portion 104 is equal to the height of the head 14, d1. Therefore, when the cap portion 104 comes into contact with the discharging surface S2, the cap portion 54 of the flushing cap unit 50 comes into contact with the bottom surface S1 of the carriage 10c. Thus, the ink reservoir 56 of the flushing cap unit 50 is covered by the bottom surface S1. Accordingly, the printer 1000 according to the fourth example has the same advantage as that according to the first example.

### E. MODIFICATION EXAMPLE

Among the components disclosed in the above-described examples, the components that are not claimed in the independent claim are additional components. Therefore, such components may be omitted where appropriate. Furthermore, the invention is not limited to the above-described examples and embodiments, and it may be embodied in various embodiments within the scope thereof. For example, the following modification examples are possible.

### E1. Modification Example 1

In the first example, after the cap portion 104 comes into contact with the head 14 and the cap portion 54 comes into contact with the cap member 15, the lifting unit 120 further raises the flushing cap unit 50 and the moisture retention cap unit 100 by a predetermined amount. Instead of this, just after the cap portion 104 comes into contact with the head 14 and the cap portion 54 comes into contact with the cap member 15, the lifting unit 120 may be stopped. This configuration can also suppress drying of ink droplets deposited on the discharging surface S2 of the head 14 and residual ink in the ink reservoir 56. Alternatively, just before the cap portion 104 comes into contact with the head 14 and the cap portion 54 comes into contact with the cap member 15, rise of the flushing cap unit 50 and the moisture retention cap unit 100 may be stopped. In this case, although a small gap is formed between the cap portion 54 and the cap member 15, in a power-off state or standby state, drying of the inside of the ink reservoir 56 can be suppressed compared to the case where the ink reservoir 56 is not covered at all.

### E2. Modification Example 2

In the respective examples, the flushing cap unit 50 serves as a member for receiving ink during the pre-discharge processing. However, a cap unit dedicated to the vacuum recovery processing may be provided instead of the flushing cap unit 50. More specifically, the vacuum recovery processing may be performed not with the moisture retention cap unit 100 but with the cap unit dedicated to the vacuum recovery processing, which is provided separately from the moisture retention cap unit 100, by covering the head 14. That is, in general, any member for receiving fluid discharged from the head during the pre-discharge processing may be used as a pre-discharge reservoir of the fluid ejecting apparatus according to the invention.

### E3. Modification Example 3

Although an ink jet printer has been described in the respective examples, the invention is not limited to the ink jet printer. The invention can be applied to any fluid ejecting apparatus that ejects fluid other than ink (examples of such fluid include liquid, liquid-state body in which particles of a functional material are dispersed, and solid body including powder that can be ejected as fluid). For example, the invention can be applied to a liquid-state body ejecting apparatus for ejecting liquid-state body containing, in a dispersed or dissolved state, a material such as an electrode material or a color material, which is used to manufacture liquid crystal displays, electroluminescence (EL) displays, or surface emitting displays. The invention can also be applied to a liquid ejecting apparatus for ejecting a living organic material, which is used to manufacture biochips, and to a liquid ejecting apparatus used as a precision pipette for ejecting a sample liquid. Furthermore, the invention can be applied to a liquid ejecting apparatus for ejecting lubricating oil to a precision machine, such as a clock or a camera, with pinpoint precision, and to a liquid ejecting apparatus for ejecting clear liquid resin such as an ultraviolet (UV) curable resin onto a substrate to form micro hemispherical lenses (optical lenses) used in an optical communication device or the like. Furthermore, the invention can be applied to a liquid ejecting apparatus for ejecting acid or alkaline etchant to etch a substrate, and to an ejecting apparatus for ejecting solid body, for example, powder such as toner.

What is claimed is:

1. A fluid ejecting apparatus that ejects fluid, the fluid ejecting apparatus comprising:
a head capable of performing effective discharge processing, in which the head discharges the fluid toward a processing object arranged at a predetermined position, and pre-discharge processing, in which the head discharges the fluid independently of the effective discharge processing;
a carriage that carries the head and adjusts a position where the head discharges the fluid;
a moisture retention head cap unit that covers a discharging surface of the head;
a pre-discharge reservoir that receives the fluid discharged from the head when the head performs the pre-discharge processing; and
an opening cap portion configured to cover an opening formed in the pre-discharge reservoir for receiving the fluid, when the moisture retention head cap unit covers the discharging surface.

2. The fluid ejecting apparatus according to claim 1, further comprising a moisturizing tank that is connected to the pre-discharge reservoir and moisturizes an inside of the pre-discharge reservoir.

3. The fluid ejecting apparatus according to claim 1, further comprising a cap-surface cap unit configured to cover a cap surface of the moisture retention head cap unit when the pre-discharge reservoir covers the discharging surface.

4. The fluid ejecting apparatus according to claim 1, wherein the opening cap portion
(i) constitutes a part of the discharging surface, and
(ii) is configured to contact the pre-discharge reservoir and cover the opening.

5. The fluid ejecting apparatus according to claim 1, wherein the opening cap portion
(i) constitutes a part of a bottom surface of the carriage, and
(ii) is configured to contact the pre-discharge reservoir and cover the opening.
